(19) United States
(12) Patent Application Publication
(10) Pub. No.: US 2017/0132598 A1
(43) Pub. Date: May 11, 2017

(54) SYSTEM FOR MANAGING TRANSMISSION OF EMAILS FROM A SENDER TO A RECIPIENT

(71) Applicant: PMTP sagl, Tremona-Mendrisio (CH)

(72) Inventor: Alfredo VILLA, Lugano Pregassona (CH)

(21) Appl. No.: 14/937,234

(22) Filed: Nov. 10, 2015

(51) Int. Cl. G06Q 20/14; H04L 12/58; G06Q 10/10; H04L 29/06

(52) U.S. Cl. CPC G06Q 20/145; H04L 63/08; H04L 51/12; G06Q 10/107

(57) ABSTRACT

A method for managing transmission of emails from a sender to a recipient, includes: providing a server system comprising a processing unit and one or more servers; providing a recipient list to the server system, comprising identification of recipients; providing a sender list for each recipient to the server system, the sender list comprising identification of authorized senders; providing a transmission fee for each authorized sender to the server system; providing a transmission fee for a non-authorized sender to the server system. The processing unit: (s1) receives an email sent by a sender towards a recipient; (s2) determines if the name of the sender of step (s1) is in the sender list of the recipient; (s3) assigns the transmission fee amount for sending the email from the server system to the recipient; (s4) prevents transmission of the email from the server until the transmission fee is paid by the sender.

### FIELD OF THE INVENTION

The present invention relates to a system and a method for managing transmission of emails from a sender to a recipient. In particular, the present invention relates to a system and a method for limiting the waste of time of reading non-useful emails.

### BACKGROUND OF THE INVENTION

Systems for filtering the incoming email of a user are known in the art, typically as “spam filters” or “spam blockers”. Spam filters usually blocks all the emails coming from predetermined users.

Advanced spam filters analyze the content of the email to determine if an email should be blocked or not. However, such an analysis is carried out by a machine, which is not actually capable of evaluating the importance of an email. Typically the “analysis” of the spam filters is limited to the search for “undesired” catch words (e.g. “offer”, “buy”, “discount”), the excessive use of images, etc.

As a result, not all the undesired emails can be blocked. Furthermore, some useful emails may be blocked, too, disadvantageously for the final user, i.e. the recipient.

Furthermore, spam filters do not allow to selectively limit the emails from a sender. In other words, a sender may be alternatively blocked or allowed. It may be the case that only some emails from a sender are important, while other should be blocked.

In addition, a professional may receive a great number of emails from his/her clients. The professional needs to spend time in reading and answering these emails. Such a time is often not profitable, as generally it is not paid. Furthermore, it diminishes the time available to the professional for other profitable activities.

In these circumstances it is not possible to apply a spam filter to the clients because important emails may be blocked.

As a result, there is the need for improved method and a system for managing transmission of an email between a sender and a recipient.

### SUMMARY OF THE INVENTION

It is an object of an embodiment of the present invention to provide such improved method and system.

In particular, it is an object of an embodiment of the present invention to provide a method and a system allowing to avoid waste of time in reading non-profitable emails.

These and other objects are achieved by a method and a system according to the independent claims.

Preferred embodiments are recited in the dependent claims.

According to an embodiment, a method for managing transmission of emails from a sender to a recipient comprises the steps of:
(a) providing a server system comprising one or more servers, the server system comprising a processing unit;
(b) providing a recipient list to the server system, comprising identification of one or more recipients;
(c) providing a sender list for each recipient of said recipient list to the server system, said sender list comprising identification of one or more senders;
(d) providing a transmission fee for each authorized sender of the sender list to the server system;
(e) providing a transmission fee for a non-authorized sender to the server system, wherein the processing unit
(s1) receives an email sent by a sender towards a recipient of the recipient list;
(s2) determines if the name of the sender of step (s1) is named in the sender list of the recipient;
(s3) assigns the amount of the transmission fee for sending the email from the server system to the recipient;
(s4) prevents transmission of the email from the server system to the recipient until the transmission fee is paid by the sender.

It should be noted that the “list” may be of any known kind that can be read and managed by the server system (in particular by the processing unit of the server system), and it is typically a digital database.

Thanks to the present embodiment, the importance of an email is not evaluated by a machine. The sender in facts may judge if its email is worth the transmission fee. As a result, all the important emails are delivered to the recipient.

Also, the recipient spends time and resources in reading and answering the emails for which a transmission fee has been paid by the sender.

This time spent by the recipient is paid by the transmission fee.

Preferably, in fact, part of the transmission fee is credited to the recipient. The other part is typically credited to the provider of the service, e.g. the owner of the server, the owner of the software implementing the above mentioned method, etc.

The transmission fee can be different between different senders. As an example, it may be decided that a first authorized sender should pay a first transmission fee to send an email to the recipient, while a second authorized sender should pay a second transmission fee (e.g. the double of the first transmission fee) to send an email to the same recipient. It may be also the case that the transmission fee for some authorized senders is zero. In other words, some sender may send emails to a recipient free of charge.

It may be also the case that the transmission fee for all the authorized senders is zero, while a transmission fee is due to non-authorized senders.

Furthermore, waste of time (and money) in reading (and possibly answering) undesired emails is also avoided. In fact, a sender may recognize that its email is not worth the transmission fee, i.e. it has no or little importance. Thanks to the present embodiment, the email does not reach the recipient.

It may also be the case that a sender may decide to pay the transmission fee, even if the importance of the email is of no or little importance. Payment of the transmission fee pays the recipient back of the time spent (i.e. “wasted” in the present case) in reading the email.

According to an embodiment, the method further comprises the step of providing a block list to the server system for at least one of the recipients, the block list comprising identification of one or more blocked users, wherein the processing unit, after the step (s1) of receiving an email from a sender prevents transmission of an email sent from a sender to a recipient, the sender being on the block list of the recipient.

Thanks to this, the recipient may decide that some senders should not be able to send him any email, regardless the payment of a fee.

This further helps in avoiding waste of time for the recipient.

It should be noted that a “sender list” and a “block list” are identified. It may be the case that the sender list and the block list are part of a single list. As an example, a single database may contain the information that a first sender is authorized, and that he should pay a pre-determined transmission fee, while a second sender is blocked, so that no emails of the second sender can reach the relevant recipient.

According to an embodiment, the method further provides the step of providing a spam blocker to the server system, wherein the processing unit, after the step of receiving an email from a sender, checks the email with the spam blocker and prevents transmission of an email from the sender to a recipient, the email being signaled as spam by the spam blocker.

As mentioned, spam blockers may provide false positives (i.e. unwanted emails allowed by the spam blocker) and false negatives (i.e. desired emails blocked by the spam blocker).

If a spam blocker is provided, the present method can handle false positive and false negatives in different ways.

As an example, in an embodiment, when a false positive occurs, an unwanted email reaches a recipient. In such a case, the time wasted by the recipient is paid back by the sender paying the transmission fee. In an embodiment, the recipient may subsequently add the sender of the unwanted email to the block list, to avoid reception of further unwanted emails.

To avoid false negatives, in a first exemplary embodiment, the processing unit may signal the sender that his/her email has been blocked.

As a result, the processing unit may e.g. ask to rephrase the email, or to pay an increased transmission fee.

In addition, or as an alternative, the processing unit may inform the recipient that an email has been blocked by the spam blocker. The recipient may thus decide to “unblock” the email, so that processing unit may treat the “unblocked” email as a normal email, i.e. with the assigning of a transmission fee, etc.

As a result, in preferred embodiment, the decision regarding whether or not an email should be blocked is not taken by the spam blocker alone.

According to an embodiment, the server system comprises a memory, the recipient list and/or the sender list being stored on the memory.

This allows the processing unit to perform quickly the steps of the method mentioned above.

According to an embodiment, the processing unit, after step (s3) of assigning the amount of the transmission fee for sending the email from the server system to the recipient, sends a payment invitation to the user to pay the required transmission fee and payment details relating payment methods.

In this embodiment, the sender is e.g. an authorized sender to whom a transmission fee has been assigned, or a non-authorized sender. Thanks to the present embodiment, the sender receives all the information allowing him to decide whether or not to pay the transmission fee (and how to possibly pay it) to let his/her email reach the recipient.

According to an embodiment, the server system hosts a web platform, configured to accept a number of registered users. Preferably, the recipients of the recipient list are registered users of the web platform. The operation of “registering” to a web platform is known in the field of web platforms.

Thanks to the web platform, the recipient(s) can easily interact with the server system. As a result they can e.g. provide to the server system the sender list of authorized senders, provide the transmission fee of the authorized senders to the servers system, etc.

According to an embodiment, also senders may register themselves to the web platform, so as to, e.g. memorize their data and to be easily recognized by the processing unit, memorize a payment method to speed up operation of sending emails, etc.

According to an embodiment, the processing unit, after the step (s1) of receiving an email from a sender determines that the sender is not registered to the web platform and invites the sender to register to the web platform.

As mentioned, an email from a registered sender is processed faster that an email from a non-registered sender.

Furthermore, the recipients may be informed that a new registered user has joined the web platform, asking them if they want to add the new user to their sender list, i.e. to make the new user an authorized sender. Subsequently, the recipient may be asked to set a transmission fee for the new authorized sender.

It has to be noted that a distinction has been made between “sender” and “recipient”. This distinction is relevant for the single email, but it does not necessarily divide the users of the web platform into two distinct categories. In fact, a first registered user of the web platform may send an email to a second registered user, and subsequently receive an email from a third registered user. In the first case, the first registered user is a “sender”, while in the second case the first user is the “recipient”.

As a result, each user of the web platform can be selectively a sender or a receiver. As a result, each registered user of the web platform may be asked to provide a sender list (to allow receiving of emails, i.e. to act as a “recipient”) and e.g. to indicate a payment method (to allow sending of emails to other registered users, i.e. act as a “sender”).

A registered user interested only in receiving emails may thus skip providing payment methods, while a registered user interested only in sending emails may skip providing a sender list.

According to an embodiment, the recipients have an email account on a server of the server system.

Thanks to this, the server system may easily manage the incoming emails of a recipient. An embodiment of the present invention further provides for a system for managing transmission of emails from a sender to a recipient, the system comprising a server system comprising one or more servers and being configured to obtain:

a recipient list comprising identification of one or more recipients;

a sender list for each recipient of the recipient list, the sender list comprising identification of one or more senders

a transmission fee for each authorized sender list;

a transmission fee for a non-authorized sender;

wherein the server system is configured to run computer executable instructions to receive an email sent by a sender towards a recipient of the recipient list;

determine if the name of the sender of step is named in the sender list of the recipient;

assign the amount of the transmission fee for sending the email from the server system to the recipient;

prevent transmission of the email from the server system to the recipient until the transmission fee is paid by the sender.

### BRIEF DESCRIPTION OF THE DRAWINGS

Other feature, advantages and details appear, by way of example only, in the following detailed description of embodiments, with reference to the accompanying drawings, in which:

FIG. 1 is a schematic view of an embodiment of the present invention;

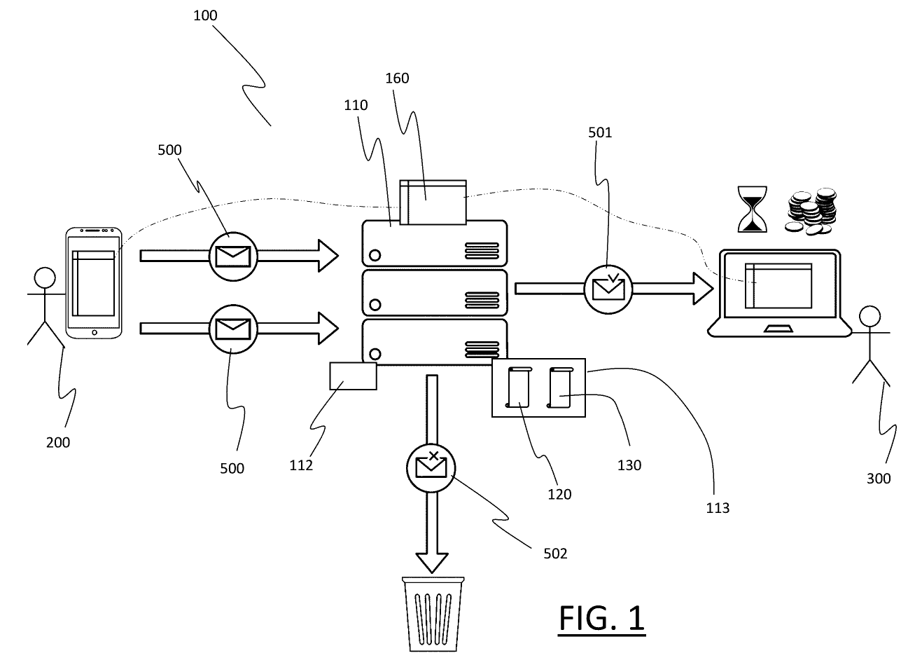

FIG. 2 is a schematic view of a recipient list of an embodiment of the present invention;

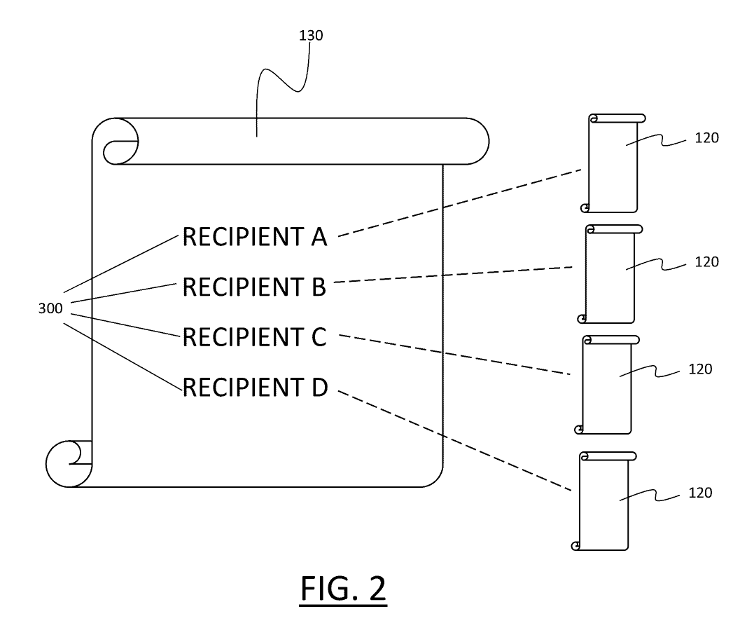

FIG. 3 is a schematic view of the content of a memory of a servers system of an embodiment of the present invention;

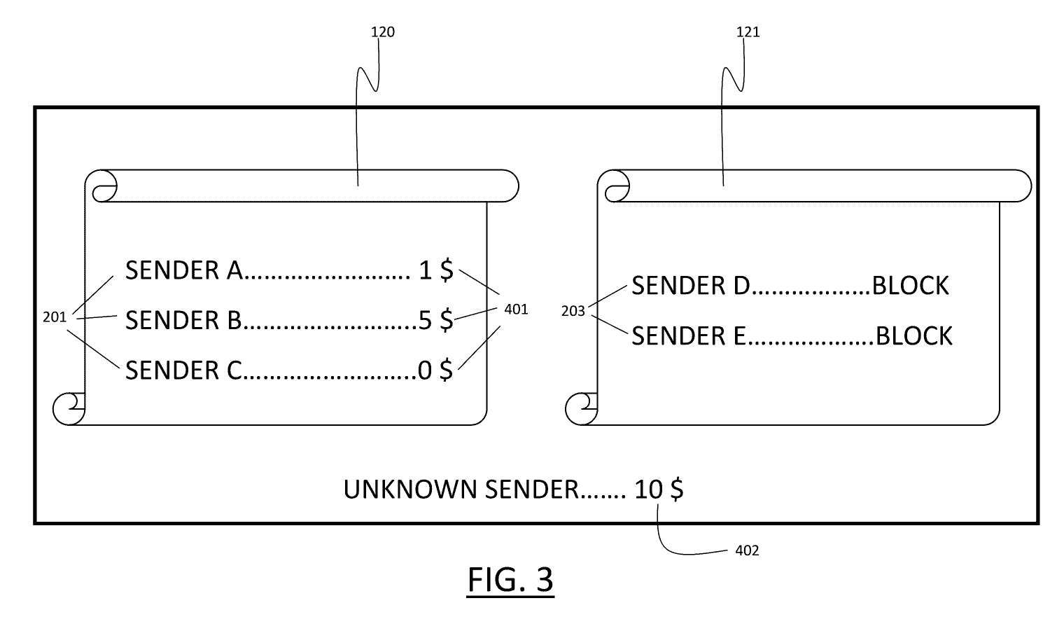

FIG. 4 is a schematic view of the content of FIG. 3, organized in a database;

FIG. 5 is a schematic view of management of the emails between registered and non-registered users of a web platform of an embodiment of the invention;

FIG. 6 is a flow-chart, showing the operation of an exemplary embodiment of the invention.

### DETAILED DESCRIPTION OF THE INVENTION

Exemplary embodiments will now be described with reference to the enclosed drawings without intent to limit application and uses.

According to an embodiment, a system 100 for managing transmission of emails 500, 501, 502 from a sender 200, 201, 202, 203 to a recipient 300. The system 100 comprises a server system 110 comprising one or more servers 111 and a processing unit 112.

In the figures, only one server 111 is shown. In other embodiments, a plurality of servers 111 may be connected in a known way, typically by means of a network over the Internet, to form a server system 110.

It should be also noted that numeric reference 500 is assigned to emails before reaching the server system, while numeric reference 501, 502 are assigned to emails after being processed by the server system 100 (in more detail by the processing unit 112 of the server system 100).

As better discussed later, emails transmitted form the server system 100 to the recipient are referenced as emails 501, while email not reaching the recipient 300 are hereinafter referenced as emails 502.

The server system 100 is configured to obtain a recipient list 130 comprising identification of one or more recipients 300 and a sender list 120 for each recipient 300 of said recipient list 130. The sender list 120 comprises identification of one or more authorized senders 201.

A sender that is not on the sender list 120 of a relevant recipient 300 is a non-authorized sender 202 for the recipient 300.

In an embodiment, the server system 100 is also configured to obtain a block list 121 for one or more of the recipients 300 of the recipient list 130. The block list 121 contains identification of one or more blocked senders 203 for a recipient.

It should be noted that when reference is made to a generic sender 200, he/she may be either an authorized sender 201, a non-authorized sender 202 or a blocked sender 203, or in general to a sender sending an email to a recipient 300.

According to an embodiment, the server system 100 is configured to obtain a transmission fee 401 for the authorized sender 201, and a transmission fee 402 for the non-authorized senders 202.

As better discussed later, a transmission fee 401, 402 is a fee that a sender should pay if he/she wants to have his/her email delivered to the recipient 300.

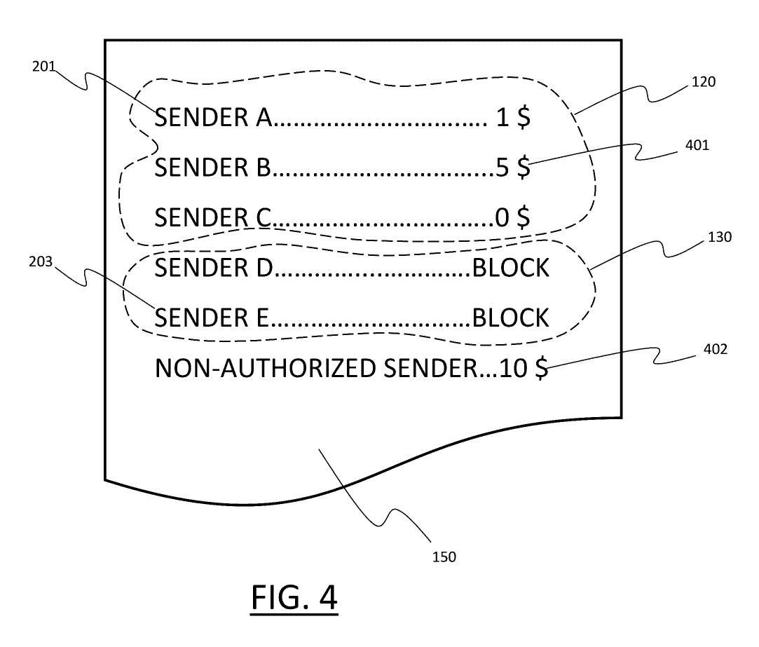

Sender list 120, block list 121, and data relating the transmission fee 402 of a non-authorized sender were disclosed as being separate and distinct elements. As shown in FIG. 4, they may be part of a single database 150.

According to an embodiment, the server system 100 is provided with a memory 113 to store, among others, the recipient list 130 and/or the sender list 120 and/or the block list 121.

In different embodiment, the above mentioned data may be stored remotely, i.e. not on the server system 100. In such an embodiment, the server system 100 should be able to retrieve the data when needed, e.g. by means of a proper connection (e.g. cabled or wireless) to the place wherein the data is stored.

According to an embodiment, the server system 100 hosts a web portal 160 (also referred as web platform).

The web portal 160 provides, among others, an interface for the senders 200 and the recipient 300.

The senders 200 and the recipient 300 can connect to the web portal 160 by way of a proper network, which is typically the Internet. The senders 200 and the recipient 300 may thus connect to the web portal by means of a device provided with Internet access, such as personal computer, mobile phones, tablets, etc.

Preferably, the web portal allows registration of users. As known in the art, a “registered user” of a web portal, is a user that, providing identification data (e.g. a username and a password) can access particular functions of the web portal 160. Moreover, a registered user can store on the web portal 160 personal information (e.g. name, email address, payment method, etc.), that allows him to quickly operate in the web portal 160, (e.g. sending an email to a recipient 300).

With “payment method” it is meant any kind of data relating payment. As an example, a user may provide to the web portal data relating its credit card, or other known digital payment services (e.g. Paypal®). Otherwise, the web platform 160 may sell “credits”, that are needed to carry out certain functions. As an example, a recipient 300 may decide that a certain sender 200 shall pay 50 credits as a transmission fee 401 for sending him an email 500.

As a result, the sender 200 should have at least 50 credits on the web portal in order to be allowed to send his/her email 500.

Furthermore, in an embodiment, the recipient 300 may receive the transmission fee in “credits”, which may be used subsequently by the recipient to carry out other operations on the web portal 160. Furthermore, in an embodiment, the recipient may be asked if he/she wants the transmission fee 401 as “credits” or as money, e.g. by a credit entry on a credit card, bank account, etc.

“Credits” may thus act as a virtual coin for carrying out the operations on the web platform 160.

In an embodiment, the recipient 300 may convert the credits obtained by the incoming emails in real money (e.g. by a credit entry in his/her bank account) after reaching a pre-determined number of credits.

In a further embodiment, the web platform 160 may manage transaction with real money (e.g. by credit card) and by credits.

Preferably, the recipients 300 are all registered users of the web portal 160. In other words, if a user wants to take advantage of the present system and method for managing its incoming emails, he should register to the web portal 160.

Senders 200 may act both as registered users and as non-registered users. In an embodiment, non-registered users will be classified as non-authorized senders 202. According to an embodiment, the system 100 provides an email address to the recipient 300. Preferably the email address share the domain of the web portal 160, i.e. it is of the type “recipient@webportal.com”.

According to an embodiment, the recipient 300 may be allowed to use its email address freely, e.g. to send emails to both registered users of the web portal 160 and to non-registered users of the web portal 160. In particular, emails to other registered users will be normally processed by the system 100. In more detail, the recipient 300 is now actually a sender, while the registered user becomes the recipient.

If an email is sent to a non-registered user, the email may be completed automatically by the processing unit 112, in order to add an invitation to register to the web portal, to take advantage of the services provided by the system itself. Alternatively the recipient 300 may be asked if he/she wants to invite the non-registered user to register to the web portal 160.

As mentioned before, the system 110 does not divide logically the “recipients” by the “senders”. The status of “recipient” and “sender” is assigned for each email managed by the system 100.

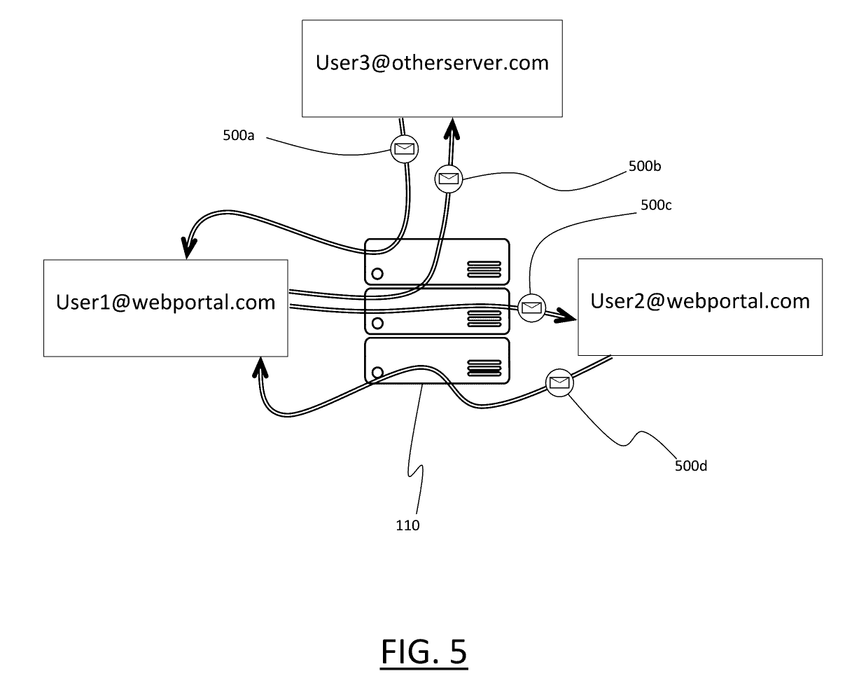

This is explained with reference to FIG. 5.

User1 and user2 are registered users of the web portal 160, and they have an email address provided by the system 100. User3 is not a registered user of the web portal 160.

Email 500a is sent by user3 to user1. In this case user3 is the sender 200 and user1 is the recipient 300. In particular, if user3 is named in the sender list 120 of user1, user3 is an authorized sender 201. If user3 is named on the block list 121 of user1, user3 is a blocked sender 203. Otherwise user1 is a non-authorized sender 202. At the reception of the email 500a, the system 100 may ask user3 to register to the web portal 160.

Email 500b is sent by user1 to user3. User3 is not registered to the web platform, so the system 100 does not carry out any particular action on the email 500b. An invitation to register to the web platform 160 may be sent to user3 together with email 500b (or user1 may be asked to invite user3 to register to the web platform 160).

Email 500c is sent by user1 to user2. In this case user1 is the sender 200 and user2 is the recipient 300. In particular, if user1 is named in the sender list 120 of user2, user1 is an authorized sender 201. If user1 is named on the block list 121 of user2, user1 is a blocked sender 203. Otherwise user1 is a non-authorized sender 202.

Email 500d is sent by user2 to user1. In this case user2 is the sender 200 and user1 is the recipient 300. In particular, if user2 is named in the sender list 120 of user1, user2 is an authorized sender 201. If user2 is named on the block list 121 of user1, user2 is a blocked sender 203. Otherwise user2 is a non-authorized sender 202

Thus, according to an embodiment, registered users of the web platform (as user1 and user2) may be either senders 200 or recipients 300 according to the case. Non-registered users may be only senders 200.

Operation of the above disclosed system 100 will be now discussed in detail.

At first, a sender 200 sends an email 500 to a recipient 300 that takes advantages of the services provided by the present system 100.

As a result, the server system 110 intercepts the email 500.

The processing unit 112 then verifies the identity of the sender 200 (typically by checking the email address of the sender 200).

The sender 200 may either be an authorized sender 201 or a non-authorized sender 202.

If the sender 200 is an authorized sender 201, the processing unit checks the transmission fee 401 associated to the sender 201.

The transmission fee may be either zero or not. If the transmission fee 401, the email 500 of the sender 200 is transmitted from the sender 201 to the recipient 300 (i.e. it becomes an email 501). In other words, if the transmission fee 401 is zero, the transmission fee is deemed as already paid.

If the transmission fee is greater than zero, the sender 201 is asked to pay the transmission fee 401.

This operation can be carried out in different ways.

As an example, in a first embodiment, the processing unit 112 may send an email to the sender 200, informing him/her that a transmission fee 401 must be paid in order to allow the email 500 to reach the recipient 300. Such an email may contain information relating the payment methods of the transmission fee 401, i.e. information relating how to pay the transmission fee 401.

In a different embodiment, wherein the server system 110 hosts a web portal 160, the sender 160 may be informed via email that he/she should connect to the web portal 160 in order to send the email. The web portal 160 may provide information relating how to pay the transmission fee.

In a different embodiment, the sender 201 (that e.g. is already aware that the recipient 300 takes advantages of the services of the present system 100) may use directly the web portal to send an email 500. As a result, the web portal 160 may inform in real time the sender 200 about the transmission fee 401 to be paid.

Furthermore, in another embodiment, the sender 201 is a registered user of the web portal 160, having a certain amount of “credits” on the web portal, or having provided to the web portal 160 information relating a preferred payment method (e.g. information relating his/her credit card).

As a result, the sender 201 may be only informed that if he continues with his/her operation, a transmission fee 401 will be charged to him/her.

Other embodiments are still possible. In general, the processing unit asks the sender 201 the payment of the transmission fee 401.

If the transmission fee 401 is paid, the processing unit 112 allows transmission of the email 500 (now email 501) to the recipient 300.

If the transmission fee is not paid, the processing unit 113 prevents transmission of the email 500 (now email 502). After a pre-determined time, email 502 is preferably deleted.

In an embodiment, an advice may be sent to the recipient 300 before deleting the email 502. If no action is taken by the recipient 300, email 502 is deleted.

If the sender is not named in the sender list 120 of authorized senders 201, the sender will be treated as a non-authorized sender.

As per above, he will be asked to pay the transmission fee 402 for non-authorized senders. Interaction between the system 100 and the sender 200 relating payment is as per above.

In case of a web portal, the non-authorized sender 202 may be either a registered user or a non-registered user.

In case he/she is not a registered user of the web platform 160, in an embodiment, he/she may be asked to register to the web platform 160.

As an example, a discount can be offered to a non-registered user if he registers to the web portal 160, or otherwise an increased transmission fee 402 may be asked to non-registered users with respect to registered users. In an embodiment, transmission of an email 500 may be denied, if the sender refuses to register to the web platform.

As before discussed, once the transmission fee 401, 402 is paid, the email reaches the recipient 300. Preferably the transmission fee 401, 402 is partly credited to the recipient 300 and partly is withheld by the system 100, e.g. it is credited to the owner of the web portal 160.

As mentioned, if the transmission fee 401 for a sender 201 is zero, the transmission fee 401 will be deemed as already paid.

As mentioned a recipient 300 may provide a block list 121, providing identification of blocked senders 203.

If the processing unit acknowledges that an email 500 is incoming by a blocked sender 203, it will prevent the transmission of the email 500 (now email 502). Email 502 may then be deleted from the server system 110.

The sender 203 and/or the recipient 300 may be informed that the email 500 has been blocked.

Similarly, if the system is provided with a spam blocker, the spam blocker may check the email 500 before allowing transmission of the email.

Preferably, emails 550 from authorized senders 201 bypass the spam blocker, i.e. the spam blocker can't block an email 500 from an authorized sender 201.

The spam blocker, if present, is preferably operated to check only emails 500 from non-authorized senders 203. If an email 500 is blocked by the spam blocker, preferably both the recipient 300 and the sender of the email are warned of the block.

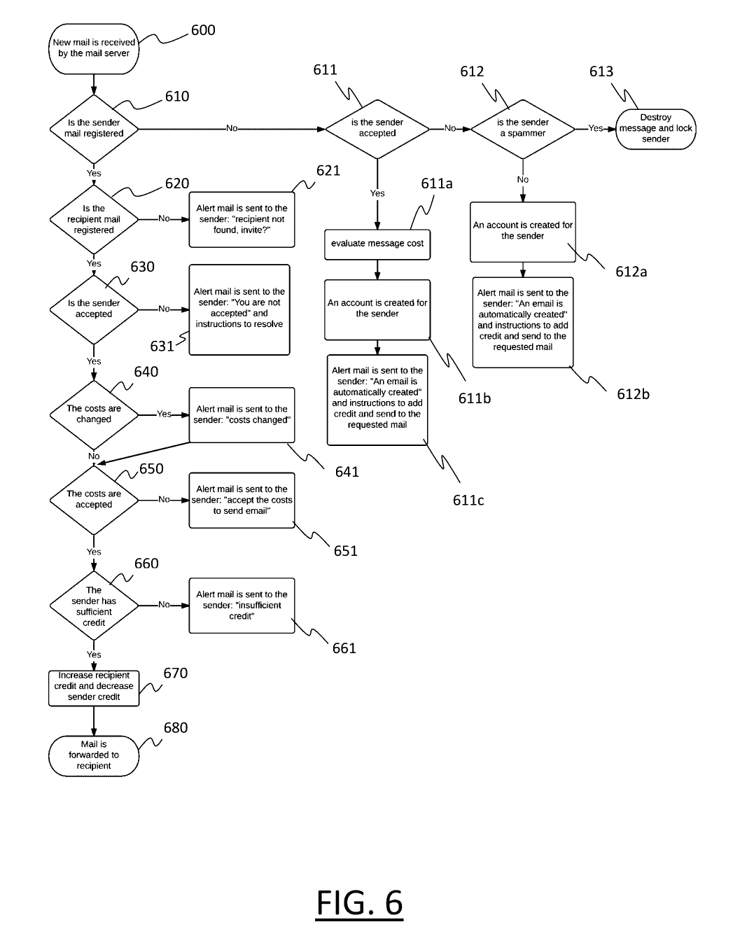

With reference to FIG. 6, operation of an exemplary embodiment is discussed. Embodiment of FIGS. 6 is provided with a web portal 160, and uses “credits” (i.e. a virtual coin of the web portal 160) as payment method.

At step 600, the server system 100 receives an email.

As shown in FIG. 5, the email could be either an email sent from a registered user of the web portal 160 to another registered user of the web portal, or an email sent from the user of the web portal 160 to a non-registered user of the web portal 160, or an email from a non-registered user of the web portal 160 to a registered user of the web portal 160.

In view of the above, the processing unit 112 first checks (step 610) if the email is sent by a registered user.

If the answer is not, the recipient is a registered user (otherwise the email would have not reached the server system 100). As a result, the processing unit should determine if the email should be transmitted to the recipient 300.

At first, the processing unit determines (step 611) if the sender 200 is an authorized sender 201 for the recipient 300.

If the answer is yes, the processing unit 112 evaluates the transmission fee 401 to be applied to the email (step 611a). In particular, the transmission fee is associated to the sender 201 in the sender list 120 of the recipient 300.

Subsequently, a temporary account is created for the sender 201, to allow him to pay the transmission fee on the web portal 160.

An email is sent to the sender (step 611c), providing him information on how to add credit to his temporary account to have his email transmitted to the recipient 300.

If the answer is no, the email is checked by the spam blocker (step 612).

If the email is not evaluated as spam, the processing unit will apply the transmission fee 402 for the non-authorized senders 202. As before, a temporary account is created (612a), allowing the sender 202 to buy the required credits to have his email transmitted.

An alert email is sent to the sender (step 612b) to inform him on how to proceed.

If the email is evaluated as spam, the message is destroyed and the sender is added to the block list 121 of the recipient 300 (step 613). The recipient 300 is notified of this fact. The email is preferably not destroyed immediately, as time may be given to the recipient to evaluate if the email is actually spam.

Turning back to step 610, if the sender is recognized as a registered user, the processing unit should evaluate if the email is directed to a registered user or to a non-registered user of the web portal 160 (step 620).

If the email is directed to a non-registered user, no further actions are carried out on the email. An alert email is sent to the sender, asking him to invite the non-registered user (step 621).

If the email is directed to a registered user, a sender 200 and a recipient 300 are identified.

At first, the processing unit evaluates if the sender is an authorized sender 201 (Step 630).

If not, the sender 200 is a non-authorized sender 202. The non-authorized sender is notified accordingly (step 631). He is also informed on how to proceed to have his email transmitted to the recipient 300 (step 631), e.g. by means of the payment of the transmission fee 402 for non-authorized senders 202.

If the sender 200 is an authorized sender 201, the processing unit check the transmission fee 401 for the sender 201 in the sender list 120 of the recipient 300.

The processing unit 112 also verifies if other emails have been sent form the sender 201 to the recipient 300, and the transmission fees previously applied to him.

Subsequently, the processing unit checks if the transmission fee 401 is changed with respect to the previous ones (step 640). If the transmission fee is actually changed, the sender 201 receives an alert email, notifying him that the transmission fee 410 is changed (step 641).

After that, the processing unit 112 waits for acceptance of the transmission fee 401 (step 650).

If at step 640 the processing units 112 evaluates that the transmission fee 401 is not changed (or that no previous emails were sent by the sender 200 to the recipient 300), step 641 is skipped and step 650 is performed directly after step 640.

If the sender 201 does not accept the payment of the transmission fee 401, an alert email is sent to the sender informing him that his email won't be transmitted to the recipient 300 until the transmission 401 fee is paid (step 651).

When the sender 201 accepts the payment of the transmission fee 401, the processing unit 112 checks if the sender 201 has sufficient credits to cover the transmission fee 401 (step 660).

If the credits are not enough, an alert email is sent to the sender 201, informing him that the credit is insufficient, and that he should buy some more credits to send his email (step 661).

When the sender buy the required number of credits (or if the sender 201 had already the required number of credits), steps 670 and 680 can be executed, i.e. the transmission fee is debited to the sender 201 and credited to the recipient 300, and the email is transmitted.

As mentioned before, preferably the transmission fee 401 is partly credited to the recipient 300 and partly to the owner of the system 100.

While exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A method for managing transmission of emails from a sender to a recipient, comprising the steps of:
(a) providing a server system comprising one or more servers, the server system comprising a processing unit;
(b) providing a recipient list to the server system, comprising identification of one or more recipients;
(c) providing a sender list for each recipient of said recipient list to the server system, said sender list comprising identification of one or more authorized senders;
(d) providing a transmission fee for each authorized sender of said sender list to the server system;
(e) providing a transmission fee for a non-authorized sender to the server system, wherein the processing unit
(s1) receives an email sent by a sender towards a recipient of said recipient list;
(s2) determines if the name of the sender of step (s1) is named in the sender list of said recipient;
(s3) assigns the amount of the transmission fee for sending the email from the server system to the recipient;
(s4) prevents transmission of the email from the server system to the recipient until the transmission fee is paid by the sender.

2. The method of claim 1, wherein, in said steps (b) and/or (d), the transmission fee is set by each recipient.

3. The method of claim 1, further comprising the step of:
(f) providing a block list to the server system for at least one of said recipients, said block list comprising identification of one or more blocked users, wherein the processing unit, after said step (s1) of receiving an email from a sender
(s1.1) prevents transmission of an email sent from a sender to a recipient, the sender being on the block list of said recipient.

4. The method according to claim 1, further providing the step of:
(g) providing a spam blocker to said server system, wherein the processing unit after said step (s1) of receiving an email from a sender
(s1.2) checks the email with the spam blocker;
(s1.3) prevents transmission of an email from the sender to a recipient, the email being signaled as spam by the spam blocker;

5. The method according to claim 1, wherein the server system comprises a memory, said recipient list and/or said sender list being stored on said memory.

6. The method according to claim 1, wherein the processing unit, after step (s3) of assigning the amount of the transmission fee for sending the email from the server system to the recipient, sends a payment invitation to the user to pay the required transmission fee and payment details relating payment methods.

7. The method according to claim 1, wherein the server system hosts a web platform, configured to accept a number of registered users.

8. The method according to claim 7, wherein the recipients of the recipient list are registered users of said web platform.

9. The method according to claim 8, wherein the processing unit, after said step (s1) of receiving an email from a sender
(s1.4) determines that the sender is not registered to the web platform
(s1.5) invites the sender to register to the web platform

10. The method according to claim 1, wherein the recipients have an email account on a server of said server system.

11. A system for managing transmission of emails from a sender to a recipient, the system comprising a server system comprising one or more servers, and a processing unit, the server system being configured to obtain:
a recipient list comprising identification of one or more recipients;
a sender list for each recipient of said recipient list, said sender list comprising identification of one or more senders
a transmission fee for each authorized sender list;
a transmission fee for a non-authorized sender;
wherein the server system is configured to run computer executable instructions to receive an email sent by a sender towards a recipient of said recipient list;
determine if the name of the sender is named in the sender list of said recipient;
assign the amount of the transmission fee for sending the email from the server system to the recipient;
prevent transmission of the email from the server system to the recipient until the transmission fee is paid by the sender

12. The system according to claim 11, comprising a memory, said recipient list and/or said sender list being stored on said memory.

13. The method according to claim 10, wherein the server system hosts a web platform configured to accept a number of registered users.
